(19) United States
(12) Patent Application Publication
(10) Pub. No.: US 2007/0024287 A1
(43) Pub. Date: Feb. 1, 2007

(54) Apparatus and method for measuring liquid conductivity and electrode series capacitance

(75) Inventors: Parker Preston Graves, Wheat Ridge, CO (US); Douglas Dwight Weerstra, Arvada, CO (US)

Correspondence Address: DORR, CARSON & BIRNEY, P.C.;ONE CHERRY CENTER, 501 SOUTH CHERRY STREET, SUITE 800, DENVER, CO, 80246, US

(73) Assignee: Mesa Laboratories, Inc.

(21) Appl. No.: 11/496,836

(22) Filed: Aug. 1, 2006

Related U.S. Application Data
(60) Provisional application No. 60/704,479, filed on Aug. 1, 2005.

(51) Int. Cl. G01N 27/60

(52) U.S. Cl. 324/453

(57) ABSTRACT

A device for measuring liquid conductivity or resistivity also quantifies series capacitance and compensates for parallel capacitance to achieve accuracy over a range of several orders of magnitude. A first signal of known frequency is applied to a conductivity cell and reference resistors, and the voltage drop across the cell is sampled. This is repeated at a second frequency. The sampled voltages are proportional to the cell's impedance, and the difference in impedance at the two frequencies allows calculation of the capacitive and resistive components of the impedance. Subtraction of the capacitive components yields resistivity measurements that are highly linear. When the cell contains a reference solution, the capacitive component can be correlated to monitor electrode surface area and thus electrode corrosion. With an unknown liquid, its contribution to capacitance can be used for species identification such as pH or concentration of components in multi-component liquids.

### RELATED APPLICATION

The present application is based on and claims priority to the Applicant's U.S. Provisional Patent Application 60/704,479, entitled “Apparatus and Method for Measuring Liquid Conductivity and Electrode Series Capacitance,” filed on Aug. 1, 2005.

### BACKGROUND OF THE INVENTION

1. Field of the Invention

The present invention relates generally to the field of measuring electrical conductivity or resistivity of a liquid, and for quantifying the double-layer series capacitance that occurs at the electrode and liquid interface. More specifically, the present invention discloses a system using impedance measurements at a plurality of frequencies to provide accurate measurements over several orders of magnitude of liquid conductivity with the ability to monitor cell electrode condition and further characterize the liquid.

2. Statement of the Problem

The measurement of conductivity or its reciprocal, resistivity, is desired in a number of applications. Conductivity measurements indicate ionic concentrations and ion mobilities in water, therefore, conductivity measurements can be used to quantify water quality or purity. In medical applications such as dialysis, dialysate fluids must have ionic concentrations that very closely match the ionic concentration of blood, which can be confirmed using conductivity measurements. In dialysis applications, the final dialysate solutions are prepared from concentrated solutions which in turn were prepared using very pure water and solid salts. This application, among many others, indicates a need for a device to measure conductivities from 0.001 mS (1 μS, typical for pure water) through 14 mS (typical for final dialysate) and to 200 mS (typical for dialysis concentrates), and to do so accurately enough to avoid patient injury.

For stable chemicals, the conductivity as a function of concentration is a repeatable value. Therefore, there are many applications where a concentration of a chemical can be inferred from the conductivity of the liquid. This analysis technique only applies to solutions containing one chemical in one solvent (typically water), yet there is need for performing a similar function for liquids containing more than one chemical.

Conductivity is quantified relative to the electrical conductance of two electrodes with a surface area of one square centimeter, separated by one centimeter distance. Conductivity is typically measured in mhos/cm, where a mho is the reciprocal of an ohm; it may be scaled to micro- (10⁻⁶) or milli- (10⁻³) mhos. Siemens is also commonly used and is identical to mhos, with milliSiemens/cm (mS) or microSiemens/cm (μS) being common units.

Conductivity is typically measured by immersing electrodes in the liquid, applying an excitation, and measuring the voltage between electrodes and the current flowing through the electrodes. Ohms law, V=IR, is then used to solve for the resistivity. However, an excitation using direct current (DC) causes ions to migrate to the electrodes, which polarizes the electrodes and causes measurement interference. An alternating current of either sine wave or square wave is commonly used.

Resistivity measurements are also commonly normalized to remove the particular cell's geometry from the measurement, that is, to provide a measurement of conductivity in terms of the one cubic centimeter definition. The cell geometry consists of electrodes of some surface area (alternatively, the cross-sectional area the electrical current must flow through) which are separated by some distance. A constant normalizing value commonly known as a cell constant is obtained by dividing the electrode area by the distance between them, usually expressed in cm, and when multiplied by the resistivity results in a normalized conductivity value, that is, the conductivity of one cubic centimeter of liquid. In many cases the cell constant value is determined by simply measuring the resistivity of a liquid of known conductivity, obtainable from the National Institute of Standards (N.I.S.T.) or traceable to said institution, and then calculating the cell constant.

The conductivity value is commonly normalized to a reference temperature by measuring the temperature and correcting to the desired reference temperature by use of a known temperature coefficient for the liquid, commonly expressed as percent per degree.

A complication for the measurement of conductivity is the presence of parasitic capacitances. Capacitance in parallel to the cell arises from the lead wires connecting the circuit to the cell, from the circuit itself (e.g. capacitance between traces on a circuit board) and from inter-electrode capacitance, the first two being the dominant sources. The total parallel capacitance is relatively constant. Capacitance in series with the liquid resistance arises at the electrode—liquid interface and is known as the double-layer series capacitance.

Capacitance in parallel presents an alternative path for AC current and causes a resistivity measurement to be abnormally low. The effect is most significant when the resistivity is high (low conductivity). Series capacitance presents an impedance to AC current, causing an abnormally high resistivity result, and its effects are most significant when the liquid's resistivity is low (at high conductivity).

The double-layer series capacitance arises as follows: when a potential is applied to the cell electrodes, ions in the liquid move toward or away from the electrode depending on the ion's polarity and the polarity of the applied potential. Thus, if the applied potential is positive, negative ions will migrate toward the electrode. The ions that are initially close to the electrode will begin to stack up at the electrode surface and parallel to this surface. This effect is in fact a charging double plate capacitor, with one plate being the electrode surface and the second plate being a virtual plate consisting of these parallel ions. The resulting capacitance value depends on the area of the plates (specifically, the area of the electrode), and the distance between the plates (specifically, the average distance between the electrode surface and the ions), and the dielectric value of space between these plates.

Further analysis shows that the magnitude of double-layer series capacitance is variant as a function of what the liquid is. In water, ions are held in solution by a surrounding number of water molecules known as the solvation sheath. The diameter of this sheath influences how close the ions can come to the electrode surface, i.e. the distance between capacitor plates. At a given potential, different ions move through the liquid at different velocities, a phenomenon called ion mobility. More mobile ions will approach the electrode surface more quickly and form the virtual plate more quickly than slower ions. The rate of formation of the virtual plate is also highly dependant on the concentration of ions. Finally, the double-layer series capacitance value is also dependant on the excitation frequency. At sufficiently high frequencies, only high mobility ions will have time to completely form the virtual plate, i.e. to form a plate of area equal to the electrode surface area.

Various efforts to measure liquid conductivity in the presence of capacitive effects are known in prior art. Many prior techniques endeavor to compensate for the effects by measuring under constant current conditions or square-wave sampling and polynomial correction techniques which do not lend themselves to broad range measurements and only approximate the necessary corrections.

Other prior art attains broad range operation and attempts to compensate for capacitance effect by actively adjusting the excitation frequency, employing a high frequency at low resistivity to minimize series capacitance and lower frequency at high resistivity to minimize parallel capacitance. This measurement technique suffers because it does not eliminate the source of the error and presumes the series capacitance is a function only of conductivity. Another prior art uses a complex system of signal phase integration to completely eliminate capacitance effects, but this technique is also difficult to implement for broad range measurements.

The bulk of prior art and existing conductivity devices suffer from using techniques whose accuracy is a function of full scale (FS) (e.g., a device with a range up to 100 mS and a specified accuracy of 0.1% FS has an accuracy of +/−0.1 mS when measuring 0.1 mS, an error which is most cases is totally unacceptable). Some devices attempt to overcome this problem by using different reference resistors at different ranges, but this introduces undesirable circuit and calibration complexities, and frequently produces measurement discontinuities at the range transition points.

Solution to the Problem. Prior art conductivity meters, apparatus or circuits have not quantified the value of the series capacitance. The present invention performs this function which allows for an accurate compensation to the measured resistivity, allows for several orders of magnitude range, and allows implementation of completely new applications and features for the invention.

### SUMMARY OF THE INVENTION

The present invention provides a method and apparatus for measuring liquid conductivity or resistivity, that also quantifies series capacitance and compensates for parallel capacitance to achieve conductivity accuracy over several orders of magnitude range. The device can be used for series capacitance quantification in fields such as pH inference or conductivity cell electrode condition monitoring. An AC signal of known frequency is applied to a conductivity cell and reference resistors. The voltage drop across the cell is sampled. The process is then repeated at a second, different frequency. The sampled voltages are proportional to the cell's impedance, and the difference in impedance at the two frequencies allows the calculation of the capacitive and resistive components within the impedance signals. Mathematical subtraction of capacitive components yields resistivity measurements which are highly linear. When the cell is exposed to a known reference solution, the capacitive component can be correlated to monitor electrode surface area and thus electrode corrosion. When exposed to an unknown liquid, its contribution to capacitance can be used for the purposes of species identification such as hydrogen ion content (pH) or concentration of components in multi-component liquids.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is an electrical schematic representing a conductivity cell with parasitic capacitances.

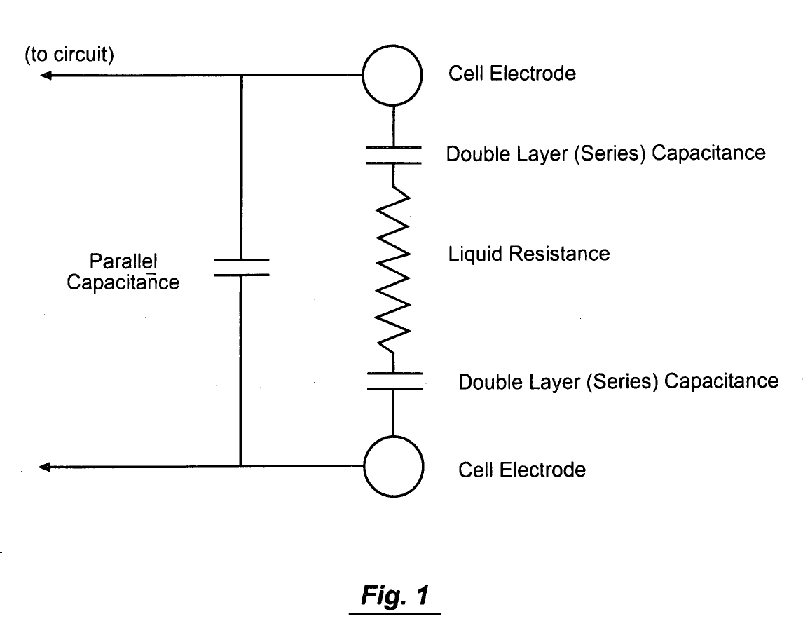

FIG. 2 is a block diagram of the measuring circuit.

FIG. 3 is a diagram showing a representation of double-layer series capacitance.

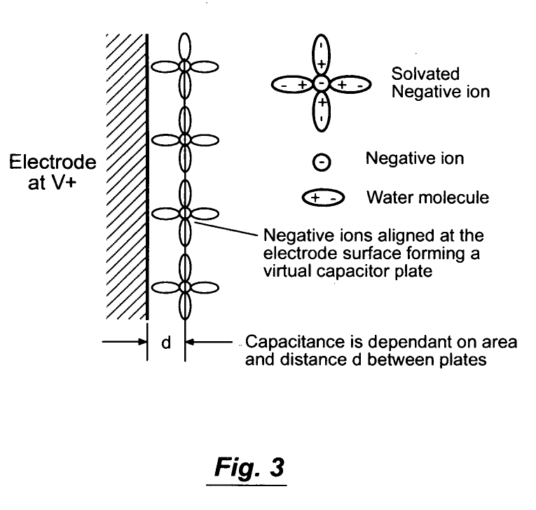

### DETAILED DESCRIPTION OF THE INVENTION

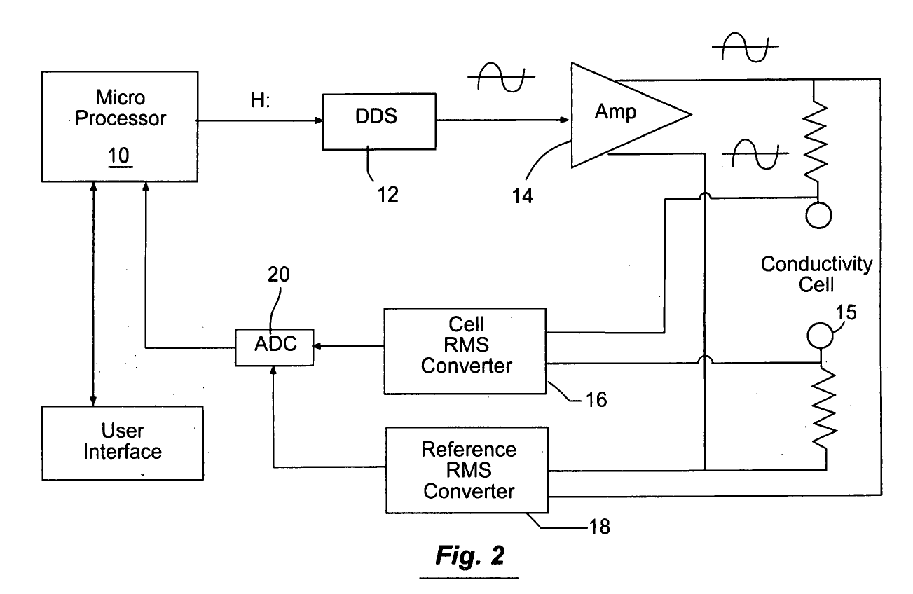

Turning to FIG. 2, a microprocessor 10 controls the generation of a AC signal of known frequency (e.g., a sine wave, square wave or other periodic waveform) by a wave generator 12. This signal is applied to a differential output amplifier 14 which produces two AC signals of opposite phase. These outputs are sampled by an RMS-to-DC converter 18 producing a DC voltage proportional to the RMS voltage difference of the AC signals. Each AC signal is also passed through a reference resistor and on to one of the conductivity cell's electrodes 15. The voltage across the cell's electrodes is sampled by a second RMS-to-DC converter 16 producing a DC voltage proportional to the liquid's resistivity and the AC signal's amplitude. This DC voltage is digitized (e.g., by a 20-bit analog-to-digital converter or ADC 20), using the first DC voltage as a reference, to produce a digital value that is proportional to liquid impedance and independent from variances in the amplifier's output amplitude.

The microprocessor 10 is capable of recording the resulting digital value and the frequency at which it was generated. The microprocessor 10 then repeats this process at a different frequency, or alternatively, at many frequencies. Upon completion of the data acquisition cycle, the microprocessor 10 converts the measured digital values into ohms, representing a dataset of the impedance as a function of frequency.

The conversion of digital values into impedance ohms is performed via an algorithm. The coefficients of this algorithm are determined by sequentially exposing the apparatus to known fixed resistors, recording the digital count, and upon completion calculating the coefficients by a multiple linear regression. This is a commonly-used technique for converting digital values obtained by an ADC into values with common units of measure. The calibration process is performed after a dry conductivity cell has been connected to the circuit. The resulting ohms value is completely free from the effects of parallel capacitance. Known fixed resistors are used with values ranging from 1 ohm to 10 MD with 2 to 3 resistors per decade, and results in an impedance accuracy which is expressed as percentage of reading, and a range commensurate with the range of the known reference resistors. The electrical reactance in ohms presented by the series capacitance is:

R_{c}=1/(2πFC)
where F is the frequency in Hertz and C is the capacitance in Farads. The total resistance to an AC signal is:
R_{T}=(R_{L}²+R_{c}²)^{1/2}
Where R_{L} is the liquid resistance. The complete equation is:
R_{T}=(R_{L}+1/(2πFC))^{1/2}

Since R_{T} is the impedance measured by the circuit at frequency F, R_{L} and C can be solved for using standard algebraic simultaneous equations techniques once measurements are made at two or more frequencies. The resulting R_{L} is the resistivity of the liquid without any capacitance effects. The microprocessor 10 then takes the reciprocal of this value (i.e., converts to mhos), multiplies by a predetermined cell constant and multiplies by any desired unit conversion factors (e.g. 1000 for mS) resulting in a conductivity value. A secondary circuit of common design measures temperature. The conductivity value can be normalized to a reference temperature by use of the measured temperature and a known temperature coefficient for the liquid.

The conductivity value obtained using this method has the desired attributes of range and accuracy, but further enhancements are implemented using the series capacitance value. Modern technology allows for the rapid reprogramming of microprocessors, their embedded mathematical functions and user interface capabilities. The present invention is the baseline circuitry which can perform the claimed functions. The inclusion of any features and functions in a final device or devices are determined by market considerations and applications.

As previously noted, the surface area of the electrodes are influential on both the cell constant and on double-layer series capacitance. Changes to the electrode surface area will introduce an error because of cell constant inaccuracy. In prior art and existing conductivity devices the problem is addressed by recalculating a cell constant via exposure to a solution of known conductivity at periodic intervals, and electrode quality is inferred from the resulting cell constant being within an expected range based on the cell geometry. In the present invention, the quality of the electrodes is inferred in a similar manner with the added evaluation of the capacitance measurements. This allows for more precise detection of electrode corrosion, cleanliness, manufacturing tolerance deviation or inadequate platinization problems by requiring both cell constant and capacitance values to be within specified ranges (per cell geometry).

The expectation of a certain capacitance value is especially important during the generation of the cell constant. The accurate calculation of the cell constant requires the accurate temperature compensation previously mentioned. Accurate temperature compensation requires the temperature coefficient for the particular liquid. Common reference solutions are made from either KCl (potassium chloride) and NaCl (sodium chloride) which have different temperature coefficients. As noted before, different species will result in a different double-layer series capacitance, and therefore, the present invention can compare the settings for the temperature compensation species to the expected capacitance for that species and prevent calibration errors.

The present invention with simultaneous conductivity and double-layer series capacitance measurement presents a completely new analytical technique for the evaluation of liquids. Unlike current conductivity devices, the present invention can distinguish between solutions of identical conductivities which are made from different chemicals or mixtures, and can derive the ratio of concentrations for solutions which are binary mixtures.

Accuracy is more easily achieved when the ionic mobilities of the two constituents are radically different. This is the case with mixtures of a salt and an acid or a salt and an alkali. Industrial processes such as roll steel pickling, chlorine production, or acidic gas scrubbing involve solutions like these, and the process efficiency can be improved or EPA compliance achieved by accurate measurement of the individual components.

Given a solution of known constituents within given ranges of concentration, a matrix encompassing possible ranges of concentrations, conductivity and double-layer series capacitance data is generated in the laboratory. This information is loaded into the microprocessor, either into a lookup table with interpolating functions or as a multiple input algorithm with coefficients generated by multiple regression. When measuring an unknown liquid of the specified constituents, the microprocessor then accurately correlates the measurement into the concentration of each chemical species (e.g., a percentage salt and a percentage alkali).

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A method for measuring the conductivity of a liquid between electrodes, said method comprising:
sequentially applying a plurality AC signals at a plurality of frequencies between the electrodes;
measuring the resulting impedance between the electrodes at each frequency; and
calculating the liquid conductivity as a function of the measured impedances.

2. The method of claim 1 wherein the AC signals are sine waves.

3. The method of claim 1 wherein the AC signals are square waves.

4. The method of claim 1 further comprising the step of calculating series capacitance as a function of the measured impedances.

5. The method of claim 1 further comprising calculating the concentration of a predetermined chemical species in the liquid as a function of the measured impedances.

6. A method for measuring the conductivity of a liquid between electrodes, said method comprising:
applying an AC signal having a first frequency between the electrodes and measuring the resulting impedance;
applying an AC signal having a second frequency between the electrodes and measuring the resulting impedance; and
calculating the liquid conductivity from the measured impedances at the first and second frequencies.

7. The method of claim 6 wherein the AC signal at the first frequency is a sine wave.

8. The method of claim 6 wherein the AC signal at the second frequency is a sine wave.

9. The method of claim 6 wherein the AC signal at the first frequency is a square wave.

10. The method of claim 6 wherein the AC signal at the second frequency is a square wave.

11. The method of claim 6 further comprising calculating series capacitance from the measured impedances at the first and second frequencies.

12. The method of claim 6 further comprising calculating the concentration of a predetermined chemical species from the measured impedances at the first and second frequencies.

13. A method for measuring the series capacitance between electrodes in a liquid cell, said method comprising:
sequentially applying a plurality AC signals at a plurality of frequencies between the electrodes;
measuring the resulting impedance between the electrodes at each frequency; and
calculating series capacitance as a function of the measured impedances.

14. The method of claim 13 further comprising calculating liquid conductance as a function of the measured impedances.

15. The method of claim 13 further comprising calculating the concentration of a predetermined chemical species from the measured impedances.
